(19) United States
(12) Patent Application Publication
(10) Pub. No.: US 2006/0069456 A1
(43) Pub. Date: Mar. 30, 2006

(54) Portable Audio Player

(76) Inventors: Gary D. Stringer, Branson, MO (US); Christopher J. Kulish, Denver, CO (US); Dorian T. Stringer, Branson, MO (US); Christopher J. Kulish, Denver, CO (US)

Correspondence Address: Gary Stringer;Design Development Resources Inc., 347 Luster Drive, Branson, MO, 65616, US

(21) Appl. No.: 10/711,718

(22) Filed: Sep. 30, 2004

(51) Int. Cl. G06F 17/00

(52) U.S. Cl. 700/94

(57) ABSTRACT

The present invention is direct to a portable audio player that substantially limits a target user to listening to the audio content that was initially established in the player during manufacture or subsequently established in the player under controlled conditions exclusive of the target user. Such an audio player provides missionaries and the like with the ability to provide an audio Bible to potential converts and especially to those potential converts that are incapable of reading a Bible that is in book or text form, such as potential converts that are visually impaired or illiterate. In one embodiment, the audio player occupies less than about twenty cubic inches and weighs less than six ounces. As a consequence, the player is highly portable. The audio player also utilizes a non-sequential-access memory, such as a disk drive and/or flash memory, to store the desired audio content. Further, the player has a keyed port that deters a target user, such as a potential convert, from downloading audio content to the memory but allows an individual with the appropriate key, such as a missionary, to download audio content to memory. In another embodiment, the player has a keyed port that deters a target user from replacing all or a portion of the memory with memory of the target user's choice but allows an individual with the appropriate key to replace all or a portion of the memory with memory of the individual's choice.

### FIELD OF THE INVENTION

The present invention is directed to a portable audio player and, in particular, to a portable audio player that substantially limits a target user to listening to the audio content that was initially established in the player during manufacture or subsequently established in the player under controlled conditions exclusive of the target user.

### BACKGROUND OF THE INVENTION

Presently, there are several portable player devices on the market that each allows a user to listen to audio content that: (a) has been downloaded to the player device from another device via a communication link; or (b) is held by a removable memory device that has been inserted into a port associated with the player. An example of a portable player device that allows a user to download audio content over a communication network is a portable MP3 player, such as the Rio Cali MP3 player. An example of the second type of portable player device is the portable compact disc (CD) player, which is capable of playing audio content that has been pre-recorded on a CD that has been placed in the player. Such player devices allow the user to listen to whatever audio content the user is able to obtain for the player.

### SUMMARY OF THE INVENTION

There are certain applications in which it is desirable to substantially limit a target user of a portable player device to listening to audio content that is established in the player by or on behalf of another. For example, many missionaries would like to be able to provide potential converts with a portable player device with Biblical related audio content but do not want the Biblical related audio content to be replaced with other audio content. It should be appreciated that a portable player device refers to a device that is of a size and weight that allows a person to transport the device on their person.

The present invention provides a portable player device that substantially limits a target user to listening to audio content (e.g., a Bible) that has been established in the player. In one embodiment, the player is comprised of: (a) a memory for holding the audio content; (b) an output interface for transmitting an audio signal representative of the audio content held in the memory; (c) an input interface that allows a user to cause audio content held in the memory to be accessed and converted into an audio signal that is provided to the output interface; (d) a controller for receiving inputs from the input interface, causing audio content held in the memory to be read, causing audio content that has been read from the memory to be converted into an audio signal, and causing an audio signal to be provided to the output interface; (e) and a housing for supporting the other elements of the player and protecting the memory and the controller. Typically, the audio content held in the memory is comprised of multiple items. For example, the memory may hold multiple items with each item being a chapter of the Bible. To facilitate the quick retrieval or access of such items, the memory employed in the player is a direct-access storage device and/or a random-access storage device. Consequently, if a location in memory that is currently being accessed is associated with Chapter 2 of the Bible and a target user wants to listen to Chapter 5 of the Bible, the target user does not have to traverse all of the memory associated with Chapters 3 and 4.The use of direct-access and/or random-access memory allows the target user to skip directly to the location in the memory at which Chapter 5 of the Bible starts. In contrast, a sequential-access memory, such as magnetic tape, requires a user to traverse all of the memory between the current location in memory and a desired location in memory to begin listening to the audio content at the desired location. The input interface of the player also does not include an input port that a target user is able to employ to download audio content to the memory and thereby erase or overwrite the audio content previously established in the memory.

In a further embodiment, the non-sequential-access memory of the player holds Biblical related information, including at least two items of Biblical related audio content and a text catalog of the items. The output interface of the player comprises, in addition to having an audio port, a display that is capable of presenting at least a portion of the text catalog. Relatedly, the input device comprises a navigation device that allows the target user to peruse, via the display, the contents of the text catalog and select an item within the catalog for playing. In a particular embodiment, the Biblical related information held in the memory comprises Biblical related text content that is capable of being presented on the display and is related to the Biblical related audio content. Moreover, the Biblical related text content is capable of being presented on the display in conjunction with the playing of the corresponding Biblical related audio content. For instance, the Biblical related text content may be the chapter and verse of a particular Biblical passage that is being played. In another embodiment, the Biblical related text content held in the memory comprises a library of scriptures that are each capable of being individually presented on the display. Further, the controller is capable of causing each of the scriptures in the library to be individually displayed on the display during a period of time. For instance, the controller can cause a particular scripture to be displayed for a day and then be replaced with another scripture that is displayed for a day. In another embodiment, the Biblical related text content comprises a concordance that allows a target user to readily find occurrences of a particular letter, group of letters, or word within the Biblical related audio content. An item within the Biblical audio content containing the particular letter, group of letters, or word can then be played.

In another embodiment, the player is relatively compact and lightweight to encourage target users to keep the player with them on a daily basis and to listen to the audio content held in the player on a daily basis. In one embodiment, the player weighs less than about six ounces and the housing of the player encloses less than about 25 cubic inches. Players that are relatively compact and lightweight also facilitate the transportation of large numbers of players. This provides a distinct advantage to, for example, a missionary traveling to a remote location because the missionary will be able to transport more players with Biblical related audio content than relatively large and heavy paper versions of a Bible.

While there are applications in which it is desirable to substantially limit a target user to listening to audio content that has been previously established in a player, it is also desirable in many applications to be able to change the audio content held in memory but still limit the target user to listening to whatever audio content is held in the memory. Consequently, another embodiment of the invention provides an input interface with a port for downloading content to the memory. However, to deter the target user from using the port to download audio content to the memory, the port is locked so that only desired audio content can be downloaded. In one embodiment, the lock is a physical feature of the port that prevents the target user from using a commercially available port engagement device to establish a physical connection with the player port. In another embodiment, an access code is employed that, although a commercially available port engagement device can be used to establish a physical connection with the player port, prevents audio content from being transmitted from the port to the memory. The access code must be entered into the player before transmissions of audio content from the port to the memory can be enabled. With such a player, a missionary could, for example, add updated Bible teachings to the memory.

In yet a further embodiment, the input interface comprises a port that is adapted to receive at least a portion of the memory. To prevent a target user from replacing the memory with another memory and audio content of their choice, the port is locked. The lock can take the form of a physical feature of the port that prevents a physical connection from being established between the port and a commercially available memory of the target user's choice. Alternatively, the lock can take the form of an access code that prevents audio content from being read from the target user's memory device even though the target user was able to establish a physical connection between the port and the memory device. The locked port also allows the memory to be updated or changed with an appropriately keyed memory. So, for example, a missionary could update or change the memory to add new Bible teachings.

### BRIEF DESCRIPTION OF THE DRAWINGS

FIG. 1 is a block diagram of a portable audio player according to the invention;

FIGS. 2A-2G are front, left side, right side, top, bottom and back views of an embodiment of a portable audio player;

FIGS. 3A-3J shows the display of the player illustrated in FIGS. 2A-2G during the menu mode of operation; and

FIG. 4 shows the display of the player illustrated in FIGS. 2A-2G during the play mode of operation.

### DETAILED DESCRIPTION

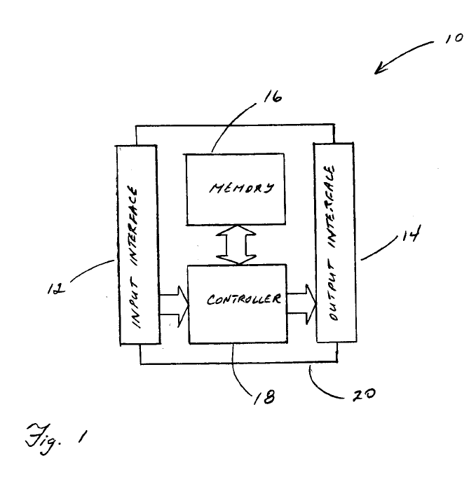

FIG. 1 is a general block diagram of an embodiment of a portable audio player 10 that substantially limits a target user of the player to listening to the audio content that is established in the player by or on behalf of another. The illustrated embodiment of a portable audio player is hereinafter referred to as player 10.

The player 10 is comprised of an input interface 12 that allows a target user to interact with the player 10 by any of one or more input interface structures. Examples of input interface structures include a push button, rotary wheel, miniature joystick, rocker switch, pen device that interacts with a display etc. The input interface 12 does not comprise a port that a target user is able to readily use to download audio content of the target user's choice into the player 10. Alternatively, the input interface 12 may comprise a port, such as a Universal Serial Bus (“USB”) port, but audio content cannot be transmitted from the port to a memory within the player 10. As another alternative, the input interface 12 may comprise a port, such as a USB port, that deters a target user from transferring audio content of the target user's choosing into the player 10 but allows a preferred user to transfer audio content into the player. This type of port allows, for example, a missionary to change the content of Biblical related audio content within the player 10 but deter a potential convert from changing the audio content in the player to audio content of the potential convert's choice. To accomplish this, a port engagement structure that physically engages the port to transfer audio content into the player 10 and the port have a key and lock structure. In one embodiment, the key is in the form of a physical feature of the port engagement structure and the lock is in the form of a corresponding physical feature of the port. The key and lock are unique relative to a commercially available port engagement structure and port. For example, the port may be a port that is in all respects identical to a commercially available USB port except for the shape of the socket portion of the port, which is incapable of accommodating a commercially available USB plug. In another embodiment, the key and lock structure is in the form of an access code. In this embodiment, the port engagement structure is capable of physically engaging the port. However, until an access code is input to the player 10 that matches the access code resident in the player, transfers of audio content are inhibited.

Further comprising the player 10 is an output interface 14 that has at least one output interface structure for providing a target user with an audio signal that is representative of audio content that is held in the player. Typically, the output structure for providing the target user with the audio signal is an audio jack suitable for receiving the plug of a headphone assembly. The output interface 14 may also include other output interface structures, such as a display that allows the target user to peruse a catalog of the items held in the player 10 and a speaker.

The player 10 further includes a memory 16 that holds the digital audio content that someone wants the target user to hear. For example, the digital audio content could be Biblical related audio content that a missionary wants a potential convert to listen to. The memory 16 is a direct-access memory (e.g., a hard disk drive) or a random-access memory (e.g., a flash memory). In many embodiments, the memory 16 is a single unit that is fixed within the player 10 and generally inaccessible to the target user. In some embodiments, the memory 16 is accessible to and removable by the target user. To assure that the target user is deterred from replacing the memory 16 with a memory and audio content of the target user's choosing, the memory 16 and the port of the player 10 that the memory engages have a key and lock structure so that only memory 16 can physically engage the port. In one embodiment, the key is in the form of a physical feature of the memory 16 and the lock is in the form of a corresponding physical feature of the port that the memory engages. The key and lock features are unique relative to commercially available memory. For example, the memory 16 may be in the form of flash memory card that is in all respects identical to a commercially available flash memory card except for a cut-off corner that is used as a key. The port of the player that receives the keyed flash memory card, in turn, has a shape that accommodates the cut-off corner but not the full corner of a commercially available flash memory. In another embodiment, the key and lock structure is in the form of a soft key or access code. In this embodiment, the memory 16 is includes an access code that is read when the memory 16 is accessed and compared to a corresponding access code otherwise resident in the player 10. With this approach, a target user may be able to establish a physical connection between a commercially available memory and the port of the player. However, because the commercially available memory will not or is very unlikely to have the access code, the player 10 will not play any of the audio content stored in the commercially available memory. It should be appreciated that a replaceable memory 16 can be replaced with another memory 16. This capability allows the audio content for the target user to be changed or updated. For instance, a missionary could replace an “old” memory 16 with a “new” memory 16 to replace the “old” Biblical teachings that have been available to the target user in the “old” memory 16 with “new” Biblical teachings that are available in the “new” memory 16.

The memory 16 can be in the form of a single, non-sequential-access memory element (e.g., a hard disk drive or a flash memory card) or can be in the form of multiple memory elements. Preferably, when the memory 16 is comprised of multiple memory elements, each of the elements is a non-sequential-access memory element. If the player 10 has a memory 16 that is capable of being comprised of multiple memory elements and there is at least one unoccupied slot for a memory element, the audio content of the memory 16 can be expanded. For example, if the player 10 includes a hard disk drive that holds an audio Bible and a slot for accommodating a memory expansion card (e.g., a flash memory), a memory expansion card that holds Biblical teachings can be inserted into the slot so that the memory 16 now includes an audio Bible and Biblical teachings.

The player 10 is further comprised of a controller 18 that receives signals from the input port, causes audio content to be read from the memory 16, causes audio content to that has been read from the memory to be converted into an audio signal, and causes audio signals to be applied to the output interface. In most cases, the audio content held in the memory is compressed. For instance, the audio content may be compressed according to the MP3 or the WMA compression algorithms. When the audio content in the memory 16 is compressed, the controller 18 causes the appropriate decompression algorithm to be utilized to decompress the audio content.

Also comprising the player 10 is a housing 20 that provides a mounting structure for the input interface 12, output interface 14, memory 16, and controller 18, and encloses at least the memory 16 and the controller 18. Typically, the housing 20 provides openings so that the portions of the input interface 12 and output interface 14 to which a target user needs to have access in order to utilize the player 10 are accessible. Any such openings can be sealed to protect the player 10 from the elements.

In one embodiment, the dimensions of the player 10 are less than the dimensions of an ordinary book. In embodiments in which a portable MP3 player (e.g., Rio Cali) is adapted to realize the player 10, the volume of the player 10 is considerably smaller than the volume occupied by an ordinary book. For example, presently there is a portable MP3 player that is capable of being adapted to realize the present invention that occupies less than five cubic inches of space and weight less than 3.5 ounces.

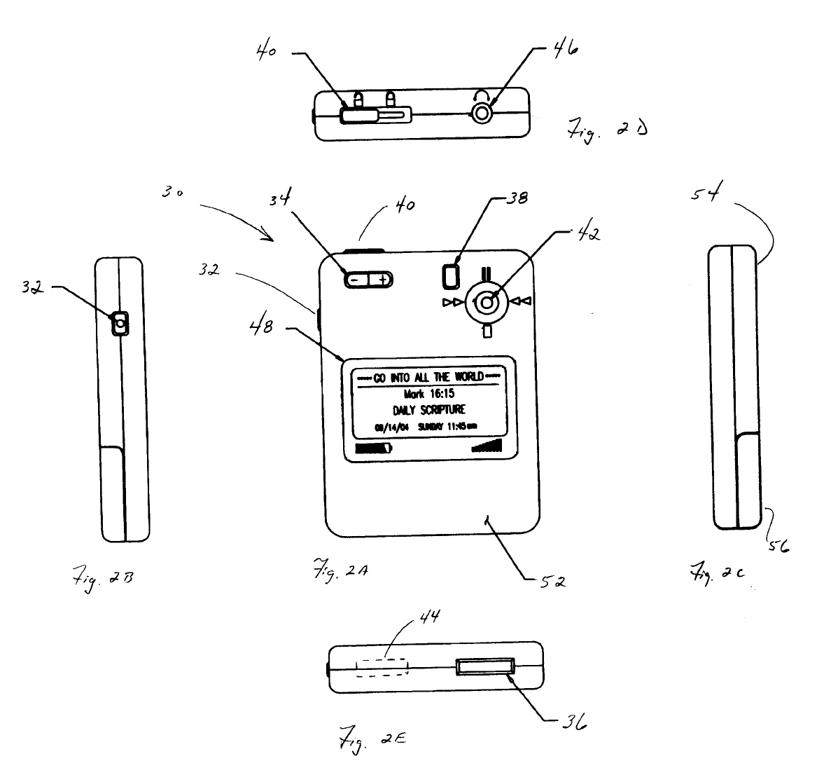

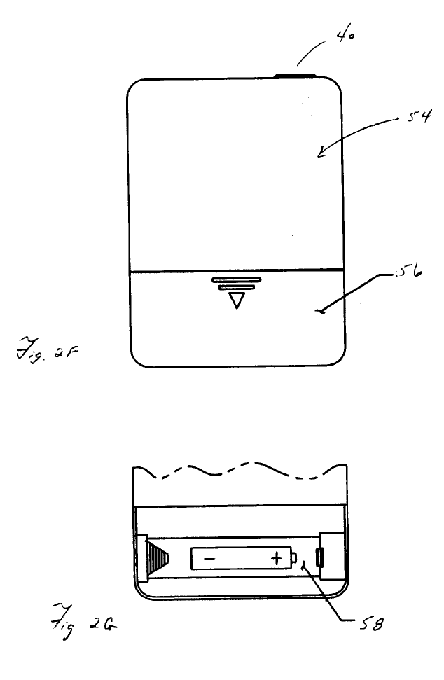

FIGS. 2A-2F illustrate another embodiment of a portable audio player that substantially limits a target user of the player to listening to the audio content that is established in the player by or on behalf of another. The illustrated embodiment of the portable audio player is hereinafter referred to as player 30.

Player 30 is comprised of an input interface that includes a power on/off switch 32, volume control 34, and an external control port 36 that allows the player 30 to be controlled and powered externally (e.g., when the player is housed within a protective carrying case). Further comprising the input interface is a menu/play mode switch 38 that the target user employs to place the player 30 in menu mode in which the user can select from a menu of play options presented on a display device associated with an output interface or a play mode in which a selection is played; a mode lock switch 40 that allows a target user to place the player 30 in a state such that an actuation of a control associated with the input interface that would otherwise cause a change of the present mode (menu or play) is ignored; and a control joystick 42 that allows a target user to navigate a menu presented on a display associated with the output interface when the player 30 is in the menu mode and to play, stop, fast forward, reverse and pause the player 30 when the player 30 is in play mode. The player 30 may also include a download port 44, such as a USB port. The download port may be permanently disabled. Alternatively, the download port may be part of a lock/key structure that allows a preferred or privileged user to download audio content to the player 30 but deters a target user from downloading audio content, as discussed with respect to player 10.

The player 30 further comprises an output interface that is comprised of an earphone jack 46 that is capable of accommodating an earphone plug that is associated with an earphone assembly. Also comprising the output interface is a LCD display 48 that is capable of presenting text content that is typically resident in the player 30. For instance, the display 48 may be used to present a portion of an index of the audio content items in the player 30.

Also comprising the player 30 are a memory and a controller that substantially function in the same manner as the memory 16 and controller 18 discussed with respect to player 10.

A housing 52 supports the other elements of the player 30, substantially encloses the memory and controller, and provides various openings through which portions of the input and output interfaces are accessible to the target user. Typically, the openings are substantially sealed to protect the components located within the housing 52 from the elements. If additional protection is warranted, the player 30 can be placed in a protective case that that allows a user to control the player 30 via the external control port 36 without opening the case. With reference to FIGS. 2F and 2G, the housing 52 comprises a back side 54 with a battery access hatch 56 that permit a target user to access a battery compartment 58 to insert or replace a battery. It should be appreciated that the player 30 is capable of being adapted to being powered by other power sources, such as solar cells and fuel cells.

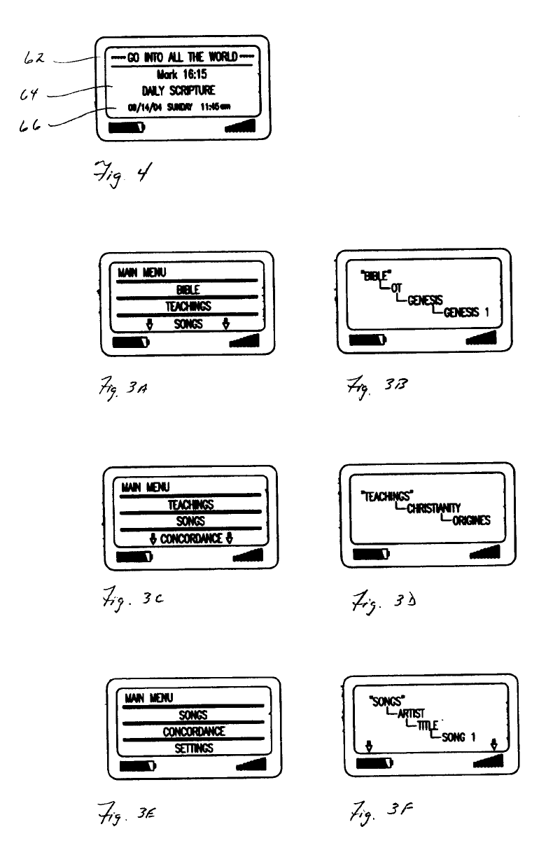

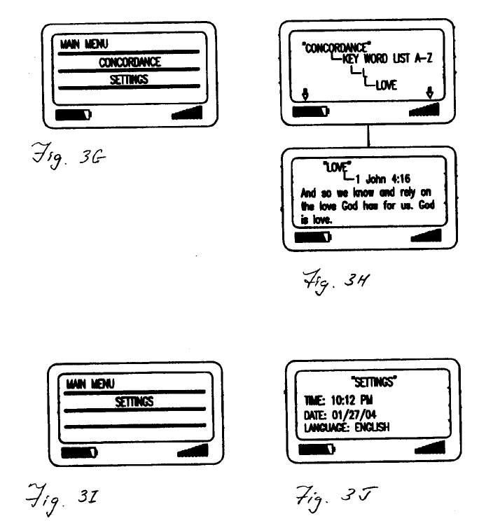

With reference to FIGS. 3A-3J, the menu mode of the player 30 is described for the situation in which Biblical related content is held in the memory of the player 30. However, before describing the menu mode, the content of the Biblical related content held in the memory of the player 30 is described. In the illustrated embodiment, the Biblical related content of the player 30 comprises Biblical related audio content and Biblical related text content. The Biblical related audio content comprises the following items: (a) all or a portion of an audio Bible, (b) Biblical teachings (e.g., lectures etc. that elaborate or explain Bible content), and (c) Biblical songs. In certain embodiments, the Biblical related audio content also includes an audio instruction set that, unless disabled, is automatically played when the player 30 is powered on. The audio instruction set facilitates the use of the player by visually impaired and illiterate individuals. The Biblical related text content comprises: (a) the words set forth in the audio Bible or portion thereof held in memory, (b) the words set forth in the Biblical teachings held in memory, (c) the words to the songs held in the memory, (d) a concordance for the audio Bible, and (e) a library of scriptures. In addition, the Biblical related text content includes an index of all of the Biblical related items held in the memory. It should be appreciated that the Biblical related content held in the player 30 is limited by the size of the memory. Consequently, a particular player may contain more or less Biblical related audio and/or text content. Further, a particular player may contain different Biblical related audio and/or text content.

Operation of the player 30 begins with the target user actuating the power on/off switch 32 to place the player 30 in an “on” state. After the player 30 is in the “on” state, the target user places the player in the menu mode by appropriately actuating the menu/play mode switch 40. In response, the controller of the player 30 causes the top or beginning of the top-level index of the items held in the memory of the player 30 to be presented on the display 48. As can be seen from FIGS. 3A, 3C, 3E, 3G and 3I, the top-level index of items includes Bible, Teachings, Songs, Concordance, and Settings. The Concordance is a structure that allows the target user to identify passages of the Bible or portion of the Bible held in memory that have a certain root word or word. The Settings relate to the date and time settings in the player 30. In addition the Settings keeps track of the appropriate language setting. In this particular embodiment, the player 30 is capable of translating audio content that is stored in memory and presented in a particular language into a number of other languages, a feature that can be very useful in missionary work. The target user navigates in the top-level index by using the control joystick 42 to move up and down in the index. In response to actuation of the joystick 42, the controller causes the top-level index to be scrolled accordingly. Whatever item in the top-level index is at the top of the display can selected to obtain (if applicable) a second-level index of sub-items for the item by pressing the joystick 44 down. In response, the controller causes a second-level index to be displayed. Specifically, FIG. 3B shows the second-level index for the Bible item in the top-level index; FIG. 3D shows the second-level index for the Teaching item in the top-level index; FIG. 3F shows the second-level index for the Song item in the top-level index; FIG. 3H shows the second-level index for the Concordance item in the top-level index; and FIG. 3J shows the second-level index for the Settings item in the top-level index. Navigation in each second-level index is accomplished using the joystick 42 and a sub-item is selected by pressing the joystick 42 down. If needed or desired, third-level indices are possible. For example, with reference to FIG. 3F, the target user is able to view a third-level index for Songs by selecting the Artist sub-item.

To enter play mode, the menu/play mode switch 38 is appropriately actuated. If the item at the top of the display 48 during the menu mode relates to Biblical related audio content, the player 30 plays the item. This involves the controller accessing the memory to retrieve the content, decompressing the content (if needed), converting the content to an audio signal, and causing the audio signal to be applied to the earphone jack 46. With reference to FIG. 4, the player 30 also presents the Biblical related text content associated with the Biblical relate audio content item that is being played. The text is presented in a scrolling text portion 62 of the display 48. For example, if a passage of Genesis is being played, the controller causes the corresponding text to be presented in the scrolling text portion 62 of the display 48.

In the play mode, the player 30 also presents a daily scripture from the library of scriptures held in memory. The daily scripture is presented in a scripture portion 64 of the display 48. The controller causes the scripture presented on the scripture portion 64 of the display 48 to change on a daily basis. More specifically, the controller causes a scripture from the library of scriptures to be presented on the scripture portion 64 of the display 48 for a day and then to be automatically replaced with another scripture that is also presented for a day.

When the player 30 is in the play mode, the controller also presents the date, day, and time, as established in the Settings, in the display 48. The date, date and time is set forth in a settings portion 66 of the display 48.

The description set forth hereinabove is intended to explain the best mode known of practicing the invention and to enable others skilled in the art to utilize the invention in various embodiments and with the various modification required by their particular applications or uses of the invention.

What is claimed is:

1. A portable audio player with audio content that a target user of the player is substantially incapable of altering, comprising:
a memory for holding audio content;
an output interface for providing an audio signal that is representative of audio content held in said memory;
an input interface for providing a user with the ability to cause audio content held by said memory to be accessed and converted into an audio signal that is provided to said output interface;
a controller for receiving input from said input interface relating to the accessing of audio content held by said memory, causing audio content to be read from said memory, causing audio content read from said memory to be converted into an audio signal, and causing an audio signal to be provided to said output interface; and
a housing for supporting said memory, output interface, input interface, and controller and protecting said memory and said controller from exterior elements;
wherein said memory comprises at least one of a direct-access storage device and a random-access storage device;
wherein said input interface does not include an input port that a target user is readily able to use to download audio content into said memory.

2. A portable audio player, as claimed in claim 1, wherein:
said input interface comprises a port that is capable of engaging a port engagement device for the purpose of downloading audio content to said memory but from which audio content cannot be provided to said memory.

3. A portable audio player, as claimed in claim 1, wherein:
said input interface comprises a port for downloading audio content to said memory; wherein said port comprises a lock for deterring a target user from downloading audio content to said memory.

4. A portable audio player, as claimed in claim 3, wherein:
said lock comprises a physical feature of said port that prevents a target user from using a port engagement device that is commercially available to the target user to establish a connection with said port.

5. A portable audio player, as claimed in claim 3, wherein:
said lock comprises an access code that, although a target user may be able to use a port engagement device that is commercially available to the target user to physically engage said port, prevents audio content from being transmitted from said port to said memory.

6. A portable audio player, as claimed in claim 1, wherein:
said input interface comprises a port that is adapted for receiving at least a portion of said memory;
wherein said port comprises a lock for deterring a target user from using a memory device that is commercially available to the target user for at least a portion of said memory.

7. A portable audio player, as claimed in claim 7, wherein:
said lock comprises a physical feature of said port that prevents a memory device that is commercially available to the target user from establishing a physical connection with said port.

8. A portable audio player, as claimed in claim 7, wherein:
said lock comprises an access code that, although a target user may be able to establish a physical connection between a memory device that is commercially available to the target user and said port, prevents audio content from being transmitted from said memory device.

9. A portable audio player, as claimed in claim 1, wherein:
said housing has dimensions that are each less than the dimensions of an ordinary book.

10. A portable audio player, as claimed in claim 1, wherein:
said housing encloses a volume that is less than about 90 cubic inches.

11. A portable audio player, as claimed in claim 1, wherein:
said memory comprises at least one of a disk drive, flash memory, and memory expansion card.

12. A portable audio player with audio content that a target user of the player is substantially incapable of altering, comprising:
a non-sequential-access memory for holding audio content;
an output interface for providing an audio signal that is representative of audio content held in said memory;
an input interface for providing a user with the ability to cause audio content held by said memory to be accessed and converted into an audio signal that is provided to said output interface;
a controller for receiving input from said input interface relating to the accessing of audio content held by said non-sequential-access memory, causing audio content to be read from said non-sequential-access memory, causing audio content read from said non-sequential-access memory to be converted into an audio signal, and causing an audio signal to be provided to said output interface; and
a housing for supporting said non-sequential-access memory, output interface, input interface, and controller and protecting said non-sequential-access memory and said controller from exterior elements;
wherein said input interface does not include an input port that a target user is readily able to use to download audio content into said non-sequential-access memory;
wherein said housing encloses less than about 50 cubic inches.

13. A portable audio player, as claimed in claim 12, wherein:
said housing encloses a volume that is less than about 25 cubic inches.

14. A portable audio player, as claimed in claim 12, wherein:
said housing encloses a volume that is less than about 15 cubic inches.

15. A portable audio player, as claimed in claim 12, wherein:
said housing encloses a volume that is less than about 10 cubic inches.

16. A portable audio player, as claimed in claim 12, wherein:
said non-sequential-access memory comprises a disk drive.

17. A portable audio player, as claimed in claim 12, wherein:
said non-sequential-access memory comprises a flash memory.

18. A portable audio player, as claimed in claim 12, wherein:
said non-sequential-access memory comprises a memory expansion card.

19. A portable audio player, as claimed in claim 12, wherein:
said non-sequential-access memory comprises at least one of a first memory and a second memory that is separate from said first memory.

20. A portable audio player, as claimed in claim 12, wherein:
said second memory is capable of being readily removed from said housing by a user.

21. A portable audio player with audio content that a target user of the player is substantially incapable of altering, comprising:
a non-sequential-access memory for holding audio content;
an output interface comprising an audio port for providing an audio signal that is representative of audio content held in said memory;
an input interface for providing a user with the ability to cause audio content held by said non-sequential-access memory to be accessed and converted into an audio signal that is provided to said output interface, said input interface not comprising an input port that a target user is readily able to use to download audio content to said non-sequential-access memory;
a controller for receiving input from said input interface relating to the accessing of audio content held by said non-sequential-access memory, causing audio content to be read from said non-sequential-access memory, causing audio content read from said non-sequential-access memory to be converted into an audio signal, and causing an audio signal to be provided to said output interface;
a housing for supporting said non-sequential-access memory, output interface, input interface, and controller and protecting said non-sequential-access memory and said controller from exterior elements, wherein said housing encloses less than about 25 cubic inches; and
Biblical related content held in said non-sequential-access memory;
wherein said Biblical related content comprises Biblical related audio content;
wherein said Biblical related audio content comprises at least two items;
wherein said Biblical related content comprises a text catalog of said at least two items;
wherein said output interface comprising a display for displaying at least a portion of said text catalog of Biblical related audio content held in said non-sequential-access memory;
wherein said input interface comprises a navigation device that allows a target user to peruse said catalog and select an item from said catalog for playing.

22. A portable audio player, as claimed in claim 21, wherein:
said Biblical related content comprises Biblical related text content that is capable of being displayed on said display.

23. A portable audio player, as claimed in claim 22, wherein:
said Biblical related text content is related to at least a portion of said Biblical related audio content.

24. A portable audio player, as claimed in claim 23, wherein:
said Biblical related text content comprises chapter and verse associated with at least a portion of said Biblical audio content.

25. A portable audio player, as claimed in claim 23, wherein:
said Biblical related text content comprises text that corresponds to at least a portion of said Biblical audio content.

26. A portable audio player, as claimed in claims 23, wherein:
said controller is capable of causing said Biblical related text content to be displayed on said display during the playing of said at least a portion of said Biblical related audio content.

27. A portable audio player, as claimed in claim 22, wherein:
said Biblical related text content comprises a library of scriptures with each scripture in said library of scriptures being capable of being individually displayed on said display.

28. A portable audio player, as claimed in claim 27, wherein:
said controller is capable of causing each of said scriptures from said library of scriptures to be individually displayed on said display during a period of time.

29. A portable audio player, as claimed in claim 22, wherein:
said Biblical related text content comprises a concordance for said Biblical related audio content.

30. A portable audio player, as claimed in claim 21, further comprising:
audio instructions on the operation of the player;
said audio instruction held in said non-sequential-access memory; and
said controller is capable of causing said audio instructions to be played in response to am actuation of a portion of said input interface.
